(19) United States
(12) Patent Application Publication
(10) Pub. No.: US 2026/0213398 A1
(43) Pub. Date: Jul. 23, 2026

(54) MICROSTRIP COMPOSITE ANTENNA FOR RECEIVING AND/OR SENDING KEYING MODULATION SIGNAL

(71) Applicant: Hamaton Automotive Technology Co.,Ltd, Hangzhou, Zhejiang (CN)

(72) Inventors: Jianer ZHANG, Hangzhou, Zhejiang (CN); Zenan HU, Hangzhou, Zhejiang (CN); Mingguang YU, Hangzhou, Zhejiang (CN); Jianing SHI, Hangzhou, Zhejiang (CN)

(73) Assignee: Hamaton Automotive Technology Co.,Ltd, Hangzhou, Zhejiang (CN)

(21) Appl. No.: 18/718,777

(22) PCT Filed: Sep. 8, 2023
(86) PCT No.: PCT/CN2023/117797

§ 371 Date: Jun. 11, 2024

(51) Int. Cl. H01Q 1/32; H01Q 9/06

(52) U.S. Cl. CPC H01Q 1/32; H01Q 9/065

(57) ABSTRACT

A microstrip composite antenna is provided, including: a microstrip radiation line including a first radiation line and a second radiation line, a first end of the first radiation line is connected to a signal input/output point, the second radiation line connected with a second end is further connected to a ground plane of a PCB; and a strip radiation antenna, both a first support section and a second support section of which are bent towards a same side of a middle section, a first pin of the first support section is connected to the second radiation line, and a second pin of the second support section is connected to the ground plane of the PCB through a capacitor; the strip radiation antenna is located above the microstrip radiation line, and at least one of the first radiation line or the second radiation line is parallel to the middle section.

### CROSS-REFERENCE TO RELATED APPLICATION

The present application is a U.S. National Stage of International Application No. PCT/CN2023/117797, filed on Sep. 8, 2023, the contents of which are incorporated herein by reference in their entirety for all purposes.

### TECHNICAL FIELD

The present disclosure relates to the field of radio technologies, and in particular, to microstrip composite antennas for receiving and/or sending keying modulation signal.

### BACKGROUND

A radio frequency (RF) antenna is an antenna configured to transmit or receive radio frequency signals. According to an installation position of the RF antenna, the RF antennas can be divided into built-in antennas and external antennas. The built-in antenna can be soldered to a printed circuit board (PCB) and assembled inside a device, which has a wide range of application scenarios.

In related arts, if a standing wave is to be obtained on a transmission line to obtain a more desirable gain for the built-in RF antenna, an antenna length usually needs to be λ/4 (where λ is a wavelength of electromagnetic wave) or an integer multiple thereof. Take a bracket antenna with the resonant frequency of 434 Megahertz (MHz) as an example, an antenna length meeting λ/4 is close to 18 centimeter (cm), which makes the PCB on which the antenna is soldered and the electronic device on which the antenna is placed must be larger in size, resulting in higher device costs.

In order to reduce the size of the antenna, the related arts propose a spiral antenna structure. Compared with the above-mentioned bracket antenna, although the spiral antenna reduces the antenna size, the gain is significantly decreased (for example, a gain of a small-sized spiral antenna with a resonant frequency of 434 MHz is about −4 to −5 dBi), and a vibration of the device will cause deformation of the spring-shaped antenna, thus changing the resonant frequency of the antenna, resulting in lower stability of its operation. In addition, the related arts further propose an RF antenna using a flexible printed circuit (FPC) technology. This kind of antenna usually needs to be stuck and fixed inside a device, and a feeder end is soldered or is buckled using IPEX. However, the firmness of this fixing method is not good, the glue used for pasting will age and fall off after long-term use, and the feeder is thin, resulting in weak anti-vibration ability, posing a risk of falling off and breaking.

It can be seen that the RF antenna in the related arts is difficult to meet the requirements of both miniaturization and high gain. Therefore, it is urgent to develop an RF antenna that can meet the requirements of miniaturization and high gain, to achieve operational stability while reducing the cost of the radio frequency antenna and the device on which the antenna is placed, thereby meeting the needs of the industry.

### SUMMARY

The present disclosure provides microstrip composite antennas for receiving and/or sending keying modulation signal, and integrated circuit boards integrating the microstrip composite antennas, to at least solve technical problems in the related arts. The technical solution of the present disclosure is as follows.

According to a first aspect of an embodiment of the present disclosure, a microstrip composite antenna is provided, the microstrip composite antenna includes a strip radiation antenna and a microstrip radiation line connected with each other, where,
the microstrip radiation line includes a first radiation line and a second radiation line printed in a printed circuit board PCB, a first end of the first radiation line is connected to a signal input/output point of the keying modulation signal, a second end of the first radiation line is connected to the second radiation line, and the second radiation line is further connected to a ground plane of the PCB;
the strip radiation antenna includes a middle section, a first support section and a second support section located at two ends of the middle section, respectively, both the first support section and the second support section are bent towards a same side of the middle section, a first pin formed at an end of the first support section is connected to the second radiation line, and the second pin formed at an end of the second support section is connected to the ground plane of the PCB through a capacitor; and
the strip radiation antenna is located above the microstrip radiation line, and at least one of the first radiation line or the second radiation line is parallel to the middle section.

According to a second aspect of an embodiment of the present disclosure, an integrated circuit board is provided, the integrated circuit board includes a controller, a signal processer, an interface and the microstrip composite antenna according to the first aspect, where,
the first end of the microstrip radiation line in the microstrip composite antenna is connected to the signal processing module, and the signal processing module is configured to perform at least one of: modulating and output keying modulation signal to the microstrip composite antenna, or to receiving and demodulate the keying modulation signal received by the microstrip composite antenna.

According to a third aspect of an embodiment of the present disclosure, a vehicle is provided, which is equipped with a microstrip composite antenna as described in the first aspect.

The technical solutions provided in the embodiments of the present disclosure at least brings the following beneficial effects:

The strip radiation antenna of this solution establishes a connection with the microstrip radiation lines printed on the PCB through the pins at both ends, and together form a microstrip composite antenna. Because the first end of the first radiation line is connected to the signal input and/or output point of the keying modulation signal, the microstrip composite antenna can be configured to receive and/or send the keying modulation signal (such as ASK, FSK, etc.).

On the one hand, compared with the bracket antenna, the size of the strip radiation antenna is not limited by λ/4, so the size of both the strip radiation antenna and the microstrip composite antenna is significantly reduced compared with the conventional bracket antenna. On the other hand, the microstrip composite antenna can work stably at the expected resonant frequency and has a high antenna gain through the mutual cooperation of the microstrip radiation line and the strip radiation antenna. For example, the measured gain near the resonant frequency of 434.4 MHz is about −1.9 dBi, which is much higher than that of a spiral antenna of similar size. Therefore, the microstrip composite antenna can effectively meet the requirements of miniaturization and high gain at the same time.

In addition, the strip radiation antenna can be made of strip metal with strong rigidity, so it is not easy to deform, thus ensuring the microstrip composite antenna to work stably at or near the resonant frequency. Moreover, because the strip radiation antenna is firmly soldered to the PCB through pins, the strip radiation antenna is provided with good anti-vibration properties, higher structural stability and signal stability.

It should be understood that the above general descriptions and the following detailed descriptions are merely for exemplary and explanatory purposes, and cannot limit the present disclosure.

### BRIEF DESCRIPTION OF DRAWINGS

The accompanying drawings are used to provide a further understanding of the present disclosure and form a part of the specification. Together with the embodiments of the present disclosure, they are used to explain the present disclosure and do not constitute a limitation on the present disclosure.

FIG. 1 is a schematic structural diagram of a strip radiation antenna according to an exemplary embodiment.

FIG. 2 is a schematic structural diagram of another strip radiation antenna according to an exemplary embodiment.

FIG. 3 is a schematic structural diagram of a further strip radiation antenna according to an exemplary embodiment.

FIG. 4 is a schematic diagram of a production process of a strip radiation antenna according to an exemplary embodiment.

FIG. 5 is a schematic structural diagram of a microstrip composite antenna according to an exemplary embodiment.

FIG. 6 is a schematic structural diagram of a ground printed line according to an exemplary embodiment.

FIG. 7 is a schematic diagram of a distance between a strip radiation antenna and a ground plane according to an exemplary embodiment.

FIG. 8 is a measured S11 and Smith impedance chart of a microstrip composite antenna according to an exemplary embodiment.

FIG. 9 is measured diagrams of radiation directions of radio frequency signals of a microstrip composite antenna according to an exemplary embodiment.

FIG. 10 is a measured gain diagram of a microstrip composite antenna according to an exemplary embodiment.

FIG. 11 is a comparison diagram of measured signal distance results between a microstrip composite antenna and a spiral antenna of similar size according to an exemplary embodiment.

FIG. 12 is schematic structural diagram of an integrated circuit board according to an exemplary embodiment.

FIG. 13 is a measured size diagram of an integrated circuit board according to an exemplary embodiment.

### DETAILED DESCRIPTION

In order to enable a person of ordinary skill in the art to better understand the technical solutions of the present disclosure, the technical solutions in the embodiments of the present disclosure will be clearly and completely described below in conjunction with the accompanying drawings.

It should be noted that, the terms “first”, “second,” etc. in the description and claims of the present disclosure and the above accompanying drawings are used to distinguish similar objects, and are not used to describe a particular order or sequence. It should be understood that the data so used can be interchanged under appropriate circumstances, so that the embodiments of the present disclosure described herein can be implemented in an order other than those illustrated or described herein. The embodiments described in the following examples do not represent all embodiments consistent with the present disclosure. On the contrary, they are merely examples of an apparatus and a method consistent with some aspects of the present disclosure described in detail in the appended claims.

In order to solve the technical problems existing in the related art, embodiments of the present disclosure propose a microstrip composite antenna which is composed of a microstrip radiation line and a strip radiation antenna and is configured to receive and/or sending keying modulation signal, so as to meet the requirements of miniaturization and high gain at the same time. The microstrip composite antenna described in the present disclosure is described in detail below in conjunction with the accompanying drawings.

The microstrip composite antenna described in the present disclosure includes a microstrip radiation line and a strip radiation antenna which are connected with each other, the microstrip radiation line includes a first radiation line and a second radiation line both printed in a PCB, a first end of the first radiation line is connected to a signal input and/or output point of the keying modulation signal, a second end of the first radiation line is connected to the second radiation line, and the second radiation line is further connected to a ground plane of the PCB.

The strip radiation antenna includes a middle section, a first support section and a second support section respectively located at two ends of the middle section, both the first support section and the second support section are bent towards a same side of the middle section, a first pin formed at an end of the first support section is connected to the second radiation line, and a second pin formed at an end of the second support section is connected to the ground plane of the PCB through a capacitor.

The strip radiation antenna is located above the microstrip radiation line, and at least one of the first radiation line or the second radiation line is parallel to the middle section.

The strip radiation antenna that constitutes the microstrip composite antenna adopts a new antenna structure proposed by the present disclosure. The structure includes a middle section, a first support section and a second support section respectively located at two ends of the middle section, and the first support section and the second support section are bent towards a same side of the middle section. The shape of the middle section is a long strip. In addition, a first pin/lead is formed at the end of the first support section, and a second pin/lead is formed at the end of the second support section, where the end of any support section is an end of the support section far from the middle section. By using the first pin and the second pin, the strip radiation antenna can be soldered on the PCB. The number of the first pin and the second pin is at least one. The structure of the strip radiation antenna will be explained below.

FIGS. 1 to 3 are schematic structural diagrams of three exemplary strip radiation antennas provided by exemplary embodiments of the present disclosure. As shown in any one of FIGS. 1 to 3, the strip radiation antenna 100 includes a first support section 101, a second support section 102, and a middle section 103, where the first support section 101 and the second support section 102 are located at two ends of the middle section 103 respectively, and both are bent toward a same side of the middle section 103. For example, when the strip radiation antenna 100 is placed in a direction shown in FIGS. 1 to 3, both the first support section 101 and the second support section 102 are bent toward a lower surface of the middle section 103, thus forming the strip radiation antenna 100 with a bench-like shape. At this time, the first support section 101 and the second support section 102 can be used to support the middle section 103, and a hollow structure is formed among the first support section 101, the second support section 102 and the middle section 103. Therefore, after the strip radiation antenna 100 is mounted on the PCB, there is a certain space between the middle section 103 and a surface of the PCB (e.g., the middle section 103 is not contact with the surface of the PCB). In addition, the first support section 101 and the second support section 102 can be bent by 90° (degrees) or close to 90°, so as to form a regular-shaped strip radiation antenna 100.

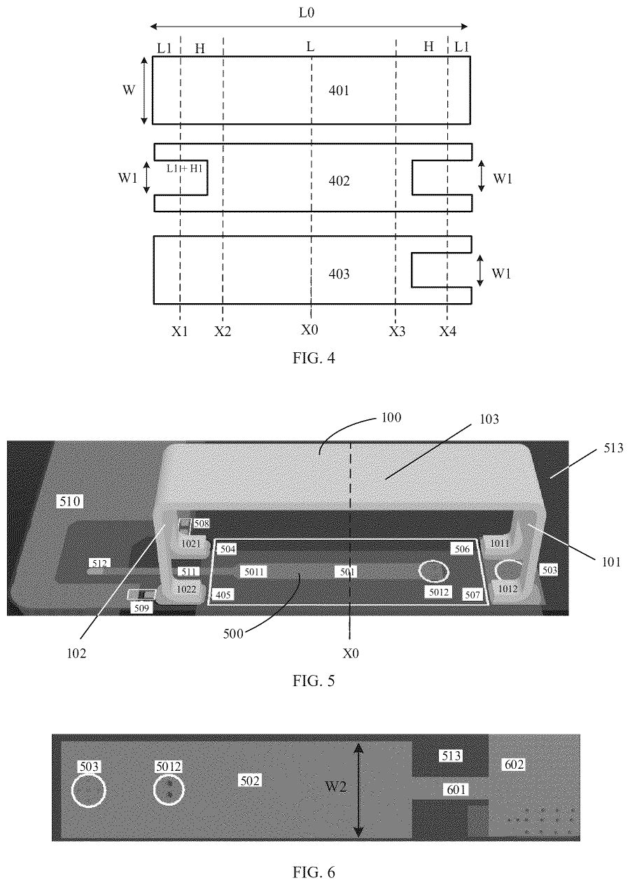

As can be seen from the strip radiation antenna 100 shown in FIGS. 1 to 3, a difference between the three is mainly due to the different number of pins. In the strip radiation antenna 100 shown in FIG. 1, two first pins, namely a pin 1011 and a pin 1012, are formed at the end of the first support section 101, and a first notch 1013 is formed between the two pins. Symmetrically, two second pins, namely a pin 1021 and a pin 1022, are formed at the end of the second support section 102, and a second notch 1023 is formed between the two pins. At this time, when viewed from the front of the strip radiation antenna 100, the antenna is axisymmetric, the first support section 101 and the second support section 102 are symmetrical with each other around a connecting line (see a dash line X0 shown in FIG. 4) between center points of two long sides of the middle section 103.

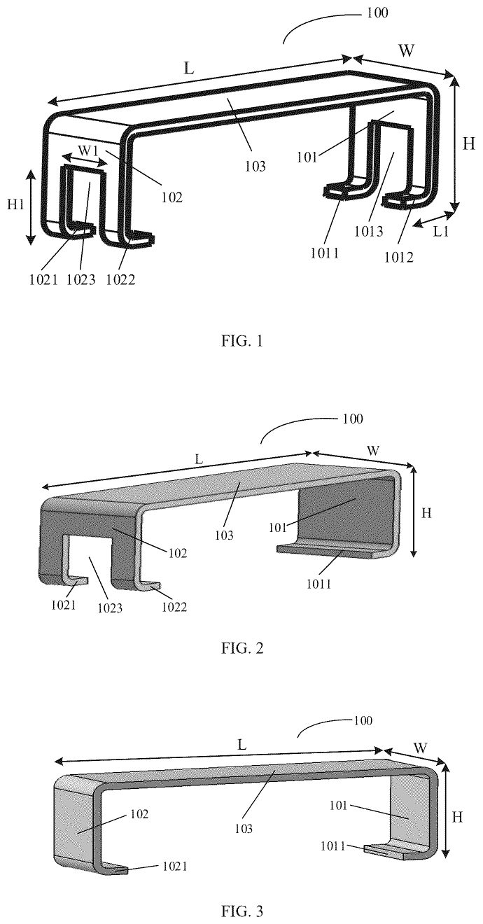

In the strip radiation antenna 100 shown in FIG. 2, one first pin, namely a pin 1011, is formed at the end of the first support section 101, two second pins, namely a pin 1021 and a pin 1022, are formed at the end of the second support section 102, and a second notch 1023 is formed between the two pins. In the strip radiation antenna 100 shown in FIG. 3, one first pin, namely a pin 1011, is formed at the end of the first support section 101, and one second pin, namely a pin 1021, is formed at the end of the second support section 102. Similar to FIG. 1, the first support section 101 and the second support section 102 of the strip radiation antenna 100 shown in FIG. 3 are also symmetrical with each other around the connecting line between the center points of the two long sides of the middle section 103.

It can be understood that FIGS. 1 to 3 are only exemplary. In fact, one or more pins can be formed at the end of any support section of the strip radiation antenna 100, in the case of forming a plurality of pins, a corresponding notch (gap) can be formed between any two adjacent pins, and the present disclosure does not impose any limitation on the number of pins and notches.

The microstrip composite antenna described in the present disclosure is a radio frequency antenna, which can be used to transmit or receive radio frequency signals in a specific frequency band (or frequency range). As a key component of microstrip composite antenna, sizes of strip radiation antenna will affect an overall frequency band of the microstrip composite antenna, so it is necessary to design its sizes reasonably.

As shown in FIGS. 1 to 3, the dimensions of the strip radiation antenna 100 mainly include a length L, a height H, and a width W. In an embodiment, if the frequency band of the microstrip composite antenna is 310 to 490 MHz, at this time, the dimension range of the strip radiation antenna can be: length L=22 to 50 millimeter (mm), height H=5 to 10 mm, width W=3 to 8 mm. The specific dimension of the strip radiation antenna 100 can be reasonably set according to actual situations, e.g., the antenna's expected parameter specifications, production process accuracy, etc., and the specific values of its dimensions are not limited in the present disclosure.

In order to reduce signal attenuation of the RF antenna and make it have higher gain, it is usually necessary to ensure that the microstrip composite antenna works in a resonant state, and an RF signal frequency at this time is a resonant frequency of the RF antenna, also known as a resonant point. Taking a common resonant frequency of 434 MHz as an example, the dimensions of the strip radiation antenna 100 can be set to be L=26 mm, H=7 mm and W=6 mm. At this time, the microstrip composite antenna can work in a frequency band of 431 to 437 MHz (e.g., 434±3 MHz), the resonant frequency of the antenna is within this frequency band and as close as possible to 434 MHz. At this time, the signal attenuation of microstrip composite antenna is relatively small, which can ensure that the antenna has high gain when its resonant frequency is in the frequency band of 431 to 437 MHz (e.g., 434 MHz).

In an embodiment, a thickness of the strip radiation antenna also needs to be set reasonably. In fact, because a current flowing through the strip radiation antenna has a skin effect, the thickness of the antenna has little influence on its working performance, it can be appropriate to choose a thinner metal sheet to produce the strip radiation antenna, so as to minimize a weight of the antenna, and reduce metal materials, thereby reducing costs. However, considering that an ultra-thin strip radiation antenna may be deformed due to vibration in the working process, or it may be deformed due to touch in the production or handling process, the above deformation will lead to signal instability, while a thicker antenna can have higher stiffness and stronger structural stability, so the antenna should have a suitable thickness. For example, the thickness of the strip radiation antenna can range from 0.2 to 1.0 mm, preferably, it can be 0.4 mm, 0.5 mm, 0.6 mm, etc.

The pins formed at the end of the support sections of the strip radiation antenna shown in FIGS. 1 to 3 all use surface mounted technology (SMT), or, any of the above pins can also be direct-inserted pins/through hole leads. In other words, any or all of the first pin and the second pin can be surface mounted or directly inserted, e.g., each first pin can be surface mounted or directly inserted, and in the case of multiple first pins, some first pins can be surface mounted and the rest can be directly inserted (as shown in FIG. 1, the pin 1011 can be surface mounted and the pin 1012 can be directly inserted). Similarly, each second pin can be surface mounted or directly inserted. In the case of multiple second pins, some second pins can be surface mounted and the rest can be directly inserted (as shown in FIG. 1, the pin 1021 can be surface mounted and the pin 1022 can be directly inserted). The specific form of the pins of the strip radiation antenna should be reasonably set according to the space on the PCB, and the embodiments of the present disclosure do not limit it.

In an embodiment, the strip radiation antenna can be formed by stamping and/or bending a strip-shaped metal sheet to obtain the middle section, the first support section, and the second support section. FIG. 4 is a schematic diagram of a production process of a strip radiation antenna according to an exemplary embodiment. As shown in FIG. 4, the strip-shaped metal sheet 401 has a length L0=L+2H+2L1 and a width W. A distance from a left edge of the metal sheet to a dash line X1 and a distance from a right edge of the metal sheet to a dash line X4 are both L1, this length will become a pin length of a mounted pin of the strip radiation antenna 100 (L1 as shown in FIG. 1). A distance between the dash line X1 and a dash line X2, and a distance between the dash line X3 and a dash line X4 are both H, this length will become the height of the strip radiation antenna 100 (H as shown in FIGS. 1 to 3). A distance between the dash line X2 and the dash line X3 is L, this length will become the length of the middle section 103 of the strip radiation antenna 100 (L as shown in FIGS. 1 to 3), and W will become the width of the strip radiation antenna 100 (W as shown in FIGS. 1 to 3). Widths of the first support section 101, the second support section 102, and the middle section 103 are equal, all of which are W.

For example, for the metal sheet 401, a bending process (e.g., bending by 90°) can be carried out first along each of the dash line X1 and the dash line X4 from the two ends of the metal sheet 401 to a direction of a center of the metal sheet (e.g., a direction towards X0), and then the bending process can be continued along each the dash line X2 and the dash line X3 in that direction, so as to obtain the strip radiation antenna 100 shown in FIG. 3. For another example, a metal sheet 402 can be obtained by cutting or stamping both ends of the metal sheet 401 (the two ends can be stamped separately or simultaneously), and notches are formed at original positions of the two stamped or cut away parts (these two parts are rectangles located at both ends of the metal sheet 401, a length of which is L1+H1 and a width of which is W1). Thereafter, a bending process (e.g., bending by 90°) can be carried out first along the dash line X1 and the dash line X4 from the two ends of the metal sheet 402 to a direction of a center of the metal sheet (e.g., a direction towards X0), and then the bending process can be continued along the dash line X2 and the dash line X3 in that direction, so as to obtain the strip radiation antenna 100 shown in FIG. 1. For a further example, a metal sheet 403 can be obtained by stamping or cutting only a right end of the metal sheet 401, and a notch is formed at an original position of the stamped or cut part. Thereafter, a bending process (e.g., bending by 90°) can be carried out first along the dash line X1 and the dash line X4 from the two ends of the metal sheet 403 to a direction of a center of the metal sheet (e.g., a direction towards X0), and then the bending process can be continued along the dash line X2 and the dash line X3 in that direction, so as to obtain the strip radiation antenna 100 shown in FIG. 2. It can be understood that in the above bending forming process, the first bending is used to form the first pin and the second pin, and the second bending is used to form the first support section 101 and the second support section 102. Through the above processing, the strip radiation antennas shown in FIGS. 1 to 3 can be obtained from the strip-shaped metal sheet 401 shown in FIG. 4.

In addition, the material of the strip radiation antenna described in the present disclosure is metal. For example, in order to achieve better radio frequency signal transceiving effect, a metal conductor with excellent conductivity such as copper or copper alloy can be selected to process the strip-shaped metal sheet 401, and the strip radiation antenna can be moulded based on the metal sheet. Or, an inner core of the strip radiation antenna can be made of non-conductive materials (such as ceramics and plastics), and then a metal conductor with uniform thickness can be formed on a surface of the inner core by electroplating or spraying, so as to obtain a finished strip radiation antenna. When the strip radiation antenna works, the metal material is used for conducting electricity, and the inner core can play a supporting role. This method can use less metal to make a lighter strip radiation antenna, thus further saving metal and helping to reduce the weight of the antenna.

In addition, anti-rust materials can be coated on the surface of the antenna by spraying or baking paint to avoid the antenna from rusting, so that the antenna can be applied to harsh environments such as high humidity and high salt. The anti-rust materials should be selected as much as possible that are not suitable for absorbing radio frequency signals, so as to reduce signal attenuation and improve antenna gain.

It should be noted that the shapes of the strip radiation antennas shown in FIGS. 1 to 3 are only exemplary, and the shapes of the strip radiation antennas, the number of pins, the types of pins, and other specifics can be reasonably set up or appropriately modified according to the actual situation in the solution practice, and the embodiments of the present disclosure do not limit this.

In the embodiments of the present disclosure, the microstrip radiation line is printed in the PCB, such that the microstrip radiation line may be formed by a conductive copper foil printed in the PCB. Pads are printed at appropriate positions on the PCB so as to solder corresponding pins of the strip radiation antenna (the pads and pins are soldered to form a firmly connected soldering joint), thus forming an electrical connection between the microstrip radiation line and the strip radiation antenna to form a microstrip composite antenna.

A substrate of the PCB described in the present disclosure can adopt any type of paper substrate, glass fiber cloth substrate, composite substrate (CEM series), laminated multilayer substrate and special material substrate (ceramic, metal core substrate, etc.). Considering that dielectric constant & of substrates made of different materials is usually different, in order to reduce signal attenuation caused by absorption of RF signals transceived by the microstrip composite antenna, it is recommended to choose materials with dielectric constant & not greater than 5.5 as the substrate of PCB.

Take the strip radiation antenna 100 shown in FIG. 1 as an example. If the antenna is soldered to the PCB 513, the antenna can be connected with the microstrip radiation line 500 printed on the PCB 513 to form a microstrip composite antenna. At this time, a relative position relationship between them can be seen in FIGS. 5 and 6, and a structure of the microstrip composite antenna will be described using this as an example.

As mentioned above, the first pin is formed at the end of the first support section 101, and the second pin is formed at the end of the second support section 102. In an embodiment, the number of the first pins can be one or more, where each of the first pins can be soldered to the PCB through a first pad at a corresponding position on the PCB. Similarly, the number of the second pins can also be one or more, where each of the second pins can also be soldered to the PCB through a second pad at a corresponding position on the PCB, and the second pad can be connected to a ground plane of the PCB through a capacitor.

For another example, if the strip radiation antenna 100 shown in FIG. 2 is soldered to the PCB 513, the PCB may be printed with pad 506 and pad 507 as shown in FIG. 5. At this time, the first pin 1011 of the strip radiation antenna 100 shown in FIG. 2 may be soldered to at least one of the two pads. Or, a pad with a larger area can be set at the positions of the pad 506 and pad 507 (e.g., covering the current positions of the pad 506 and pad 507, and the shape of the pad can match a shape of a bottom surface of the first pin 1011 shown in FIG. 2), and the first pin 1011 can be soldered to the pad. A soldering method of the second pins (e.g., pins 1021 and 1022) of the strip radiation antenna 100 shown in FIG. 2 can be seen in FIG. 5, and will not be described again.

For a further example, if the strip radiation antenna 100 shown in FIG. 3 is soldered to the PCB 513, a pad with a larger area can be printed on the PCB corresponding to the pad 506 and pad 507 (e.g., covering the current positions of the pad 506 and pad 507, and the shape of the pad can match the shape of the bottom surface of the first pin 1011 shown in FIG. 3), and the first pin 1011 can be soldered to the pad. Similarly, if the strip radiation antenna 100 shown in FIG. 3 is soldered to the PCB 513, a pad with a larger area can be printed on the PCB 513 at the positions corresponding to the pad 504 and pad 505 (e.g., covering the current positions of the pad 504 and pad 505, and the shape of the pad can match the shape of the bottom surface of the second pin 1021 shown in FIG. 3), and the second pin 1021 can be soldered to the pad, which will not be described again.

Through the soldering between the pins and the pads, a firm connection between the strip radiation antenna and the PCB can be realized. The number of the first pins or the second pins and the number of the corresponding pads can be reasonably set according to the actual conditions such as antenna performance and board space, and this is not limited by the embodiments of the present disclosure.

As shown in FIG. 5, corresponding to the four pins of the strip radiation antenna 100, there are corresponding pads set on the PCB 513, namely a first pad (pad 506 and pad 507) and a second pad (pad 504 and pad 505). The pin 1011 and the pin 1012 are soldered to the pad 506 and the pad 507, respectively, and the pin 1021 and the pin 1022 are soldered to the pad 504 and the pad 505, respectively. In addition, the first pad is connected to a second radiation line 502 printed in the PCB 513. The second pad is connected to the ground plane through a capacitor, such as the pad 504 is connected to the ground plane 510 through a capacitor 508 and the pad 505 is connected to the ground plane 510 through a capacitor 509.

As mentioned above, any pin of the strip radiation antenna 100 can be surface mounted or directly inserted. Since the first support section 101 and the second support section 102 are located at the two ends of the middle section 103, in order to shorten an overall length of the strip radiation antenna 100 and save the space of the PCB 513 as much as possible, any mounted pin of the mounting type may be bent towards another pin, that is, towards the center direction of the strip radiation antenna 100. For example, in the case that the first pin is surface mounted, it can be bent toward the second pin, and/or, in the case that the second pin is surface mounted, it can be bent toward the first pin. As shown in FIGS. 1 to 3, each pin is bent toward the center direction of the middle section 103 (e.g., each pin is bent inward), so that the overall length L of the strip radiation antenna 100 is shorter (e.g., equal to the length of the middle section 103).

Of course, if there is sufficient space on the PCB 513, any of the aforementioned pins can also be bent away from the other pin, which can increase a distance between the first pin and the second pin and reduce the soldering difficulty of the strip radiation antenna 100.

As shown in FIGS. 5 and 6, the microstrip radiation line 500 printed within the PCB 513 includes two portions: a first radiation line 501 and a second radiation line 502. A first end 5011 of the first radiation line 501 is connected to a signal input and/or output point 512 of the keying modulation signal. It can be understood that if the microstrip composite antenna receives a keying modulation signal modulated (or coded) by a signal modulation module through the signal input and/or output point 512 (at this time, the signal input and/or output point 512 is used as a signal input end of the microstrip composite antenna), the microstrip composite antenna can be used as a transmitting antenna to transmit the keying modulation signal (in a form of radio frequency signal) to the surrounding space, and the signal transmitted to the surrounding space can be regarded as an output signal of the microstrip composite antenna. Or, if the microstrip composite antenna receives a keying modulation signal (which is essentially a radio frequency signal) modulated by a signal source and sent by other antennas from the surrounding space, it can output the signal to a signal demodulation module through the signal input and/or output point 512 (at this time, the signal input and/or output point 512 is used as a signal output end of the microstrip composite antenna), so that the module can demodulate (or decode) the keying modulation signal. At this time, the received keying modulation signal received from the surrounding space can be regarded as input signal of the microstrip composite antenna.

The signal input and/or output point 512 to which the first end 5011 of the first radiation line 501 is connected can only be used as a signal input end of the microstrip composite antenna, can only be used as a signal output end of the microstrip composite antenna, or can be used as both a signal input end and a signal output end of the microstrip composite antenna. In the case of being used as both the signal input end and the signal output end of the microstrip composite antenna, the microstrip composite antenna is a transceiver antenna, which can work in a simplex (only receiving or transmitting RF signals at the same time) or a duplex (receiving and transmitting RF signals at the same time) mode, and the specific connection mode and its working mode can be set as required, which is not limited by the embodiments of the present disclosure. In addition, the signal input and/or output point 512 can be connected to a signal input end or signal output end through a 50 ohm impedance line such as a coaxial cable signal line or a PCB line.

In an embodiment, the signal can have different types due to different modulation/demodulation algorithms corresponding to the keying modulation signal. For example, the keying modulation signal may include at least one of the following: a frequency shift keying (FSK) signal, an amplitude shift keying (ASK) signal, or a phase shift keying (PSK) signal. No matter FSK, ASK or PSK signals, they are quite different from the pulse position modulation (PPM) signal in related arts.

Take the ASK signal as an example, if the signal input and/or output point 512 is used as the signal input end of the microstrip composite antenna, the signal modulation module connected to the signal input end can use an ASK algorithm to encode the signal to be output, and output the encoded ASK signal to the first end 5011 of the first radiation line 501, so that the microstrip composite antenna can transmit the signal to the surrounding space as the radio frequency signal. At this time, the microstrip composite antenna can be integrated into an ASK transmitter. Or, if the signal input and/or output point 512 is used as the signal output end of the microstrip composite antenna, the signal demodulation module connected to the signal output end can use the ASK algorithm to decode the ASK signal received by the microstrip composite antenna, and output the decoded signal to a back end for further processing. At this time, the microstrip composite antenna can be integrated into an ASK receiver.

In an embodiment, the PCB 513 may include n layers for routing lines, 2≤n, and the PCB 513 is a multilayer board. At this time, the first radiation line 501 and the second radiation line 502 can be located at an i-th layer and a j-th layer in the n layers of lines respectively, where 1≤i≤n, 1≤j≤n, and i≠j. According to i≠j, the first radiation line 501 and the second radiation line 502 are located in different layers, so they can be connected across layers, for example, the first radiation line 501 can be connected to the second radiation line 502 across layers. The embodiments of the present disclosure do not limit relative sizes of i and j. In other words, it does not limit relative positions of the first radiation line 501 and the second radiation line 502. The first radiation line 501 may be on the top (closer to the strip radiation antenna 100) or the second radiation line 502 may be on the top, which is not repeated here. Because the first radiation line 501 and the second radiation line 502 are located in different layers, it is necessary to realize cross-layer connection between them through a three-dimensional transmission line to effectively transmit the radio frequency signal. At this time, the microstrip radiation line 500 and the strip radiation antenna 100 can form a coplanar waveguide to achieve better signal coupling effect.

In addition, according to specific values of i and j, the cross-layer connection can be realized in various ways, such as via (through hole), buried via, blind via and/or cross lines, which is not limited by the embodiments of the present disclosure.

In another embodiment, the first radiation line 501 and the second radiation line 502 can also be located in a same layer, such as a first layer in a multi-layer board or a same layer in a single-layer board (there is only one layer at this time). In this scenario, the first radiation line 501 and the second radiation line 502 can be kept parallel, for example, they are both strip-shaped and their axes are symmetrically distributed with a projection axis of an orthogonal projection of the middle section 103 on the PCB, e.g., the first radiation line 501 and the second radiation line 502 are located on both sides of the projection axis respectively. At this time, the microstrip radiation line 500 can also approximately form a coplanar waveguide with the strip radiation antenna 100, thereby achieving a certain degree of signal coupling.

In an embodiment, the first radiation line 501 can be located on a first layer below the middle section 103, and the second pin is soldered to the PCB 513 through a second pad located in the first layer. Moreover, the signal input and/or output point 512 and the first end 5011 of the first radiation line 501 are located on both sides of the second support section 102 of the strip radiation antenna 100, respectively. The first end 5011 located on one side of the second support section 102 is connected to the signal input and/or output point 512 located on the other side of the second support section 102 through an extension wire 511. The aforementioned “first layer below” does not distinguish the front or back sides of the PCB, but only indicates that the strip radiation antenna 100 is soldered to a certain surface of the PCB, and the “first layer below” is the first layer counted down from the surface, such as a top layer or a bottom layer of the PCB. In view of the fact that the second pin of the strip radiation antenna 100 is directly soldered to the surface of the PCB 513, in order to connect the signal input and/or output points 512 with the first end 5011 which are located on both sides of the second support section 102, the extension wire 511 can be laid out in various ways.

For example, the extension wire 511 is connected to the first end 5011 bypassing the second pad in the first layer. If the strip radiation antenna 100 shown in FIG. 5 is replaced by the strip radiation antenna 100 shown in FIG. 3 (the antenna has only one second pin 1021), the extension wire 511 can bypass the pad corresponding to the second pin 1021 in the first layer and connect to the first end 5011. Or, as shown in FIG. 5, if the ground plane 510 of the first layer does not surround the signal input and/or output point 512, the extension wire 511 can be connected to the first end 5011 by bypassing the pad 504 (e.g., routing from the outside of the pad 504) or pad 505 (e.g., routing from the outside of the pad 505) in the first layer.

For another example, in view of the fact that the layout mode of bypassing the pad in the first layer has strict requirements on a layout mode of components in the first layer, in order to avoid bypassing the pad, a notch 1023 (the aforementioned second notch 1023) can also be set at the end of the second support section 102, and at this time, the extension wire 511 can pass under the notch 1023. For details, please refer to FIG. 5.

At the same time, the first notch 1013 is formed at the end of the first support section of the strip radiation antenna 100 shown in FIG. 5. These two notches can ensure that the radio frequency signal emitted by the strip radiation antenna 100 are distributed as symmetrically and evenly as possible in the surrounding space, which is helpful to improve the coverage of antenna signal.

Further, when the extension wire 511 passes underneath the notch 1023, the end of the second support section 102 may form two symmetrical second pins, such as pin 1021 and pin 1022, centered on the notch 1023. Each of the two second pins may connect to the ground plane 510 of the PCB 513 through at least one capacitor. For example, the pin 1021 is connected to the ground plane 510 through the capacitor 508. For another example, the pin 1022 can also be connected to the ground plane 510 in series or in parallel through two capacitors 509 and 509′ (not shown in FIG. 5). Or, one of the two second pins can be connected to the ground plane 510 of the PCB 513 through at least one capacitor, while the other second pin is vacant, e.g., a corresponding pad is not connected to any signal. In this way, it is only necessary to produce the strip radiation antenna (including two second pins) in a fixed size and manner, without frequently changing a production process of the strip radiation antenna, which is helpful to improve the production efficiency of the strip radiation antenna and its structural compatibility with the PCB.

It can be understood that the more the total number of capacitors connected between the second support section 102 and the ground plane 510, the higher the adjustment precision for adjusting the resonant frequency of the microstrip composite antenna through capacitors, and the more convenient it is to realize the accurate adjustment of the resonant frequency. The number of capacitors can't increase indefinitely, and it needs to be considered comprehensively according to various factors such as capacitor size, board space size and soldering accuracy. In addition, since the capacitance value of the mounted capacitor is usually a fixed value, it may be difficult to ensure that the microstrip composite antenna works at or near the resonant frequency through capacitor selection in some scenarios. Therefore, an adjustable capacitor can be connected between the second pad and the ground plane 510, so as to adjust the resonant frequency of the antenna more accurately by adjusting the capacitance value of the adjustable capacitor.

In order to achieve better signal transceiving effect, a width of the notch 1023 should be not less than 1.2 times a width of the extension wire 511. As shown in FIG. 5, a width W1 of a notch between the pin 1021 and the pin 1022 (i.e., the second notch 1023) should be greater than or equal to 1.2 times the width of the extension wire 511. In addition, considering that the width of each position of the extension wire 511 can be the same or different, the width W1 of the notch 1023 should be at least 1.2 times greater than or equal to the width of the part of the extension wire 511 between the pin 1021 and the pin 1022.

In the embodiments of the present disclosure, a second end 5012 of the first radiation line 501 is connected to the second radiation line 502, and the second radiation line 502 is further connected to the ground plane of the PCB 513. Taking PCB 513 as a multilayer board, the first radiation line 501 and the second radiation line 502 are respectively located in the i-th and j-th layers as an example. As shown in FIG. 5, the second end 5012 located in the i-th layer (such as the first layer) is connected to the second radiation line 502 located in the j-th layer (such as the second layer) through a via (the j-th layer can refer to FIG. 6). And then it returns to the first layer through a via 503 covered by the second radiation line 502, and extends horizontally within the first layer to connect to the pin 506 and the pin 507. At this time, cross-layer connection is directly realized between the i-th layer line and the j-th layer line through the vias (e.g., the via at the second end 5012 and the via 503). In addition, the second radiation line 502 can be connected to the ground plane 602 of the j-th layer through a bridge connection line 601. It is also possible to directly extend the second radiation line 502 to connect with the ground plane 602 without providing the bridge connection line 601.

In addition, it should be noted that the ground plane 510 shown in FIG. 5 (located at the i-th layer) and the ground plane 602 shown in FIG. 6 (located at the j-th layer) are both zero-potential planes of the PCB 513. In fact, the ground planes of each layer can be connected with each other to achieve the same zero potential inside the entire PCB 513, avoiding the phenomenon of “virtual ground”. Therefore, the ground plane 510 and the ground plane 610 can be regarded as the same ground plane, which is the ground plane GND of the PCB.

In the embodiments of the present disclosure, the strip radiation antenna 100 is located above the microstrip radiation line 500, and at least one of the first radiation line 501 or the second radiation line 502 is parallel to the middle section 103 of the strip radiation antenna 100. As shown in FIG. 5, the central axes of the first radiation line 501 and the second radiation line 502 are both parallel to the central axis of the middle section 103 (i.e., the central axes of all three are coplanar), while the second radiation line 502 is located below the first radiation line 501 and further away from a longitudinal direction of the strip radiation antenna 100.

In an embodiment, a length of the first radiation line 501 is not less than half of a length of the middle section 103. In other words, an orthographic projection of the second end 5012 of the first radiation line 501 on the middle section 103 is located on the side of the middle section 103 close to the first support section 101. As shown in FIG. 5, the dash line X0 indicates a center position of the middle section 103 (in the direction of the length L), and the second end 5012 is located between the dash line X0 and the first support section 101 (i.e., to the right of the broken line X0).

In an embodiment, a ratio of a width W2 of the second radiation line 502 to a width W of the strip radiation antenna 100 should range from 0.8 to 1.2, that is, a difference between W2 and W should not exceed 20% of W. Preferably, the W2 should be equal to the W, and at this time, a signal coupling degree between the second radiation line 502 and the strip radiation antenna 100 is better.

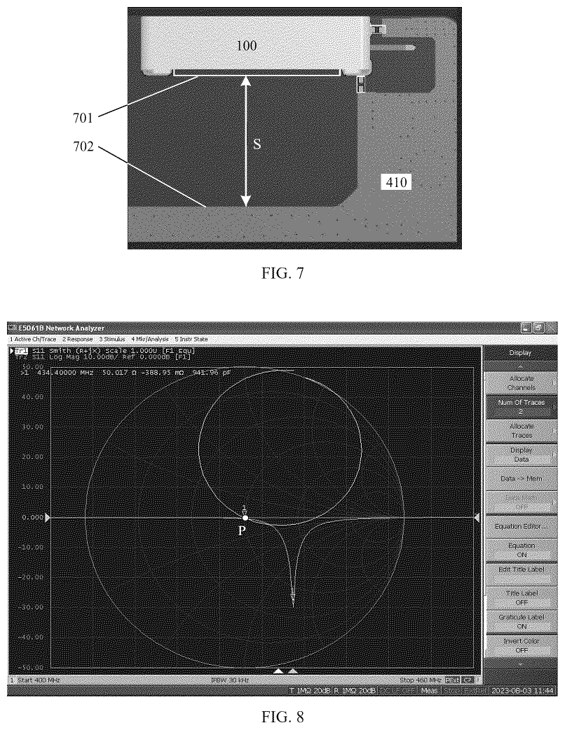

In an embodiment, in order to reduce interference caused by the ground plane to the radio frequency signal received and transmitted by the strip radiation antenna (such as absorbing signal), the strip radiation antenna should be located as far away from the ground plane as possible. For example, if a long side of an orthogonal projection of the strip radiation antenna 100 on the PCB 513 is parallel to at least one edge of the ground plane 510, a distance between the long side and the edge should be not less than 6 mm. As shown in FIG. 7, a long side 701 of the orthogonal projection of the strip radiation antenna 100 on the PCB 513 is parallel to an edge 702 of the ground plane 410. At this time, the distance S between the long side 701 and the edge 702 should be not less than 6 mm to minimize the possible interference of the ground plane 410 on the working process of the strip radiation antenna 100.

In an embodiment, a signal processor/signal processing module can also be integrated in the PCB 513 where the microstrip composite antenna is located, and the module can be connected to the signal input and/or output point 512. The signal processing module can be configured to demodulate keying modulation signals received through the microstrip composite antenna and/or to output modulated keying modulation signals to the microstrip composite antenna, so as to transmit the signals to the surrounding space through the antenna. When the signal processing module modulates or demodulates the keying modulation signals, corresponding keying algorithms should be used, such as obtaining the ASK signal by modulating or demodulating the ASK signal through the ASK algorithm, obtaining the FSK signal by modulating or demodulating the FSK signal through the FSK algorithm, obtaining the PSK signal by modulating the PSK algorithm or demodulating the PSK signal through the PSK algorithm, etc. In addition, it can be understood that when the signal processing module demodulates the keying modulation signal, it is implemented as the aforementioned signal demodulation module. When the signal processing module modulates the keying modulation signal, it is implemented as the aforementioned signal modulation module. In fact, the aforementioned signal demodulation module and signal modulation module may be functional units integrated in the signal processing module.

In addition, a control module (such as microcontroller unit, MCU) and an interface circuit (not shown in the figures) can be integrated in the PCB 513, and the interface circuit can integrate relevant interfaces such as power supply and communication, so as to supply power to the PCB 513 and establish communication with other devices (or functional modules of other devices) for data interaction. In this way, the microstrip composite antenna and related functional modules described in the present disclosure can be highly integrated on the PCB 513, thus further realizing miniaturization and integration of functional modules.

The strip radiation antenna of this solution establishes a connection with the microstrip radiation lines printed on the PCB through the pins at both ends, and together form a microstrip composite antenna. Because the first end of the first radiation line is connected to the signal input and/or output point of the keying modulation signal, the microstrip composite antenna can be configured to receive and/or send the keying modulation signal (such as ASK, FSK, etc.).

On the one hand, compared with the bracket antenna, the size of the strip radiation antenna is not limited by λ/4, so the size of both the strip radiation antenna and the microstrip composite antenna is significantly reduced compared with the conventional bracket antenna. On the other hand, the microstrip composite antenna can work stably at the expected resonant frequency and has a high antenna gain through the mutual cooperation of the microstrip radiation line and the strip radiation antenna. For example, the gain at the measured resonant frequency of 434.4 MHz is about −1.9 dBi, which is much higher than that of a spiral antenna of similar size.

Therefore, the microstrip composite antenna can effectively meet the requirements of miniaturization and high gain at the same time. In addition, the strip radiation antenna can be made of strip metal with strong rigidity, so it is not easy to deform, thus ensuring the microstrip composite antenna to work stably at or near the resonant frequency. Moreover, because the strip radiation antenna is firmly soldered to the PCB through pins, the strip radiation antenna is provided with good anti-vibration properties, higher structural stability and signal stability.

At this point, the structure of microstrip composite antenna is introduced, and its actual performance is explained with experimental data.

For example, a strip radiation antenna with a length of L=26 mm, a height of H=7 mm and a width of W=6 mm is soldered to a PCB and connected with microstrip radiation lines routed in the board to form a microstrip composite antenna as shown in FIG. 5. Connect a first end to a signal output end via a 50 ohm coaxial cable (that is, use the antenna as a receiving antenna), draw a Smith chart through a vector network analyzer, and observe positions of Mark points at a set frequency (such as 434 MHz) in combination with the S11 (return loss) view. During the test, the resonant frequency of the microstrip composite antenna is changed by adjusting the capacitor values of capacitors 508 and 509.

As shown in a measured S11 and Smith impedance chart in FIG. 8, when the resonant frequency of the microstrip composite antenna is adjusted to 434.4 MHz (that is, at point P in the figure), a real part of the impedance of the antenna is 383.95 megohm (mΩ) and an imaginary part thereof is 941.96 picofarad (pF).

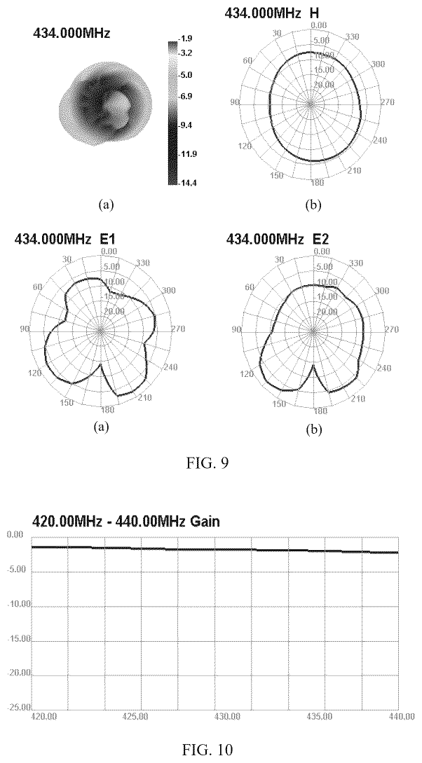

As shown in measured diagrams of radiation directions of radio frequency signals in FIG. 9, it can be seen from FIG. 9(b), (c) and (d) that when the microstrip composite antenna works at 434.00 Mhz, its maximum gain on a H-plane (e.g., xy-plane) is located near 210° direction, on a E1-plane (e.g., xz-plane) is located near the 210° direction, and on a E2-plane (e.g., yz-plane) is located near 135° direction. As can be seen from FIG. 9(a), an overall maximum gain of the microstrip composite antenna is −1.9 dBi, and a measured gain diagram shown in FIG. 10 shows a variation curve of antenna gain in the frequency band of 420.00 to 440.00 MHz, which is also proved by a gain value around 434.00 MHz.

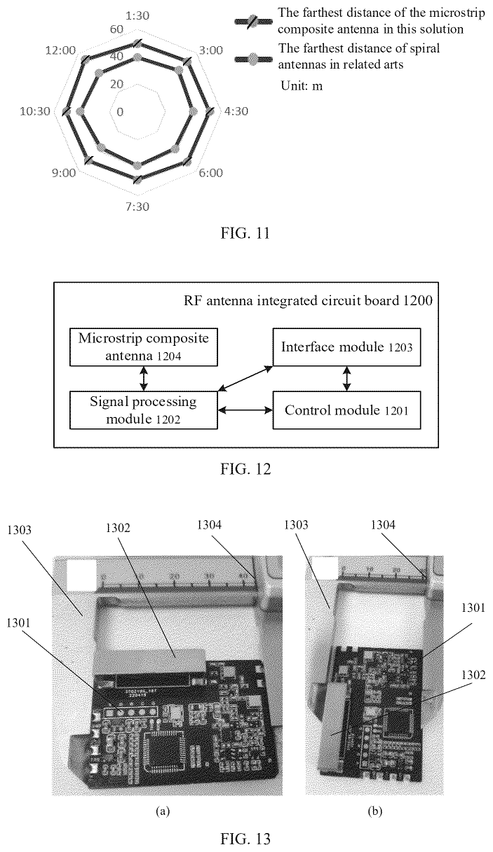

In addition, a comparative test was conducted on the signal distance between the aforementioned microstrip composite antenna in the solution and a similarly sized spiral antenna, where the two antennas are configured to receive radio frequency signals (e.g., carrying tire pressure information collected by a sensor) sent by the TPMS sensor. The test conditions are as follows. The RF communication rate is set to 19.2 kbps, FSK receiving sensitivity is set to −102 dBm, and signal power of the TPMS sensor is 5 dBm. The sensor is placed in a fixed position (coordinate zero) as a signal source to start the test, and test results can be seen in FIG. 11. As shown in FIG. 11, a farthest receiving distance of the microstrip composite antenna in this solution is about 50 m, and the farthest receiving distance in eight directions around the signal source is relatively uniform, generally within 49 to 53 m. Under the same test conditions, a farthest receiving distance of spiral antennas with similar dimensions (length L=38.5 mm, diameter D=5.5 mm) is generally about 40 m. It can be seen that the farthest signal receiving distance of the microstrip composite antenna described in the present disclosure is about 20% higher than that of the similar size spiral antenna.

From the above tests, it can be seen that the performance parameters of the microstrip composite antenna described in the present disclosure, such as the gain and the farthest signal receiving distance, are excellent, and the performance is obviously improved compared with that of the spiral antenna.

In addition to the microstrip composite antenna, the present disclosure further proposes an integrated circuit board with highly integrated components and functions. The integrated circuit board includes a control module, a signal processing module, an interface module, and the microstrip composite antenna according to any of the previous embodiments, where a first end of the microstrip radiation line in the microstrip composite antenna is connected with the signal processing module.

As shown in FIG. 12, the integrated circuit board 1200 includes a control module 1201, a signal processing module 1202, an interface module 1203 and a microstrip composite antenna 1204. The control module 1201 is configured to control a normal operation of the integrated circuit board 1200. The signal processing module 1202 is configured to demodulate the keying modulation signal received through the microstrip composite antenna 1204 and/or for transmit the modulated keying modulation signal to the surrounding space through the microstrip composite antenna 1204. The interface module 1203 can integrate various interfaces such as power supply interface and communication interface, and through this module, the power and communication connection between the integrated circuit board 1200 and other devices can be realized.

Because the size of the strip radiation antenna in this solution is small, the miniaturization of the microstrip composite antenna can be realized. Further, an integrated circuit board equipped with the microstrip composite antenna can also have a smaller size. As shown in FIG. 13, a microstrip composite antenna 1302 is mounted on an integrated circuit board 1301. Using a vernier caliper 1303 to measure the size of the integrated circuit board 1301, it can be seen from readings 1304 in (a) and (b) that the circuit board is about 30 mm in length and 42 mm in width. It can be seen that the size of an integrated circuit board equipped with a miniaturized and high-gain microstrip composite antenna is only 30 mm*42 mm, which is significantly smaller than that of a circuit board equipped with a conventional antenna (such as a bracket antenna), thus realizing the miniaturization of the circuit board (based on a small-sized microstrip composite antenna). In fact, if the functional module assembled on the integrated circuit board 1301 is simplified, its size can be further reduced to meet application scenarios with more stringent size requirements.

In an embodiment, the microstrip composite antenna described in the present disclosure can be assembled in a vehicle as an independent antenna, or the integrated circuit board described in the present disclosure can also be integrated in a vehicle as a signal processing device integrated with an antenna module. In this regard, the present disclosure further proposes a vehicle, which is equipped with a microstrip composite antenna as described in any of the previous embodiments, or an integrated circuit board as described in any of the previous embodiments.

For example, the microstrip composite antenna or integrated circuit board assembled in the vehicle can be configured to receive tire pressure, temperature, humidity and other signals emitted by tire pressure sensors (or TPMS sensors) installed in the vehicle tires, and submit them to a vehicle's computer system after appropriate processing for easy archiving and/or display to users for viewing.

Those skilled in the art will readily conceive other embodiments of the present disclosure upon consideration of the specification and practice of the various embodiments disclosed herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It should be understood that this disclosure is not limited to the precise structure that has been described above and shown in the drawings, and various modifications and changes can be made without departing from its scope. The scope of this specification is limited by the appended claims.

It is to be noted that the relational terms such as “first” and “second” used herein are merely intended to distinguish one entity or operation from another entity or operation rather than to require or imply any such actual relation or order existing between these entities or operations. Also, the term “including”, “containing” or any variation thereof is intended to encompass non-exclusive inclusion, so that a process, method, article or device including a series of elements includes not only those elements but also other elements not listed explicitly or those elements inherent to such a process, method, article or device. Without more restrictions, the elements defined by the sentence “including a . . . ” do not exclude the existence of other identical elements in the process, method, product or device including the element.

The methods and apparatuses provided in the present disclosure are described in detail above. The principle and implementations of the present disclosure are described herein by using specific examples. The descriptions of the foregoing embodiments are merely used for helping understand the method and core ideas of the present disclosure. In addition, a person of ordinary skill in the art can make variations to the present disclosure in terms of the specific implementations and disclosure scopes according to the ideas of the present disclosure. Therefore, the content of this specification shall not be construed as a limit on the present disclosure.

1. A microstrip composite antenna, comprising a strip radiation antenna and a microstrip radiation line connected with each other, wherein,
the microstrip radiation line comprises a first radiation line and a second radiation line printed in a printed circuit board (PCB), a first end of the first radiation line is connected to a signal input and/or output point of a keying modulation signal, a second end of the first radiation line is connected to the second radiation line, and the second radiation line is further connected to a ground plane of the PCB;
the strip radiation antenna comprises a middle section, a first support section and a second support section located at two ends of the middle section, respectively, both the first support section and the second support section are bent towards a same side of the middle section, a first pin formed at an end of the first support section is connected to the second radiation line, and the second pin formed at an end of the second support section is connected to the ground plane of the PCB through a capacitor; and
the strip radiation antenna is located above the microstrip radiation line, and at least one of the first radiation line or the second radiation line is parallel to the middle section.

2. The microstrip composite antenna according to claim 1, wherein the keying modulation signal comprises at least one of: a frequency shift keying (FSK) signal, an amplitude shift keying (ASK) signal or a phase shift keying (PSK) signal.

3. The microstrip composite antenna according to claim 1, wherein,
a number of the first pin is one or more, and each of the first pin is soldered to the PCB through a first pad at a corresponding position on the PCB; and
a number of the second pin is one or more, and each of the second pin is soldered to the PCB through a second pad at a corresponding position on the PCB, and the second pad is connected to the ground plane through the capacitor.

4. The microstrip composite antenna according to claim 1, wherein any or all of the first pin and the second pin are surface mounted or directly inserted.

5. The microstrip composite antenna according to claim 4, comprising at least one of:
the first pin is surface mounted and bent towards the second pin; or,
the second pin is surface mounted and bent towards the first pin.

6. The microstrip composite antenna according to claim 1, wherein the PCB comprises n layers of lines, 2≤n, the first radiation line is located at an i-th layer and the second radiation line is located at a j-th layer of the n layers of lines, 1≤i≤n, 1≤j≤n, i≠j, and the first radiation line is connected across layers to the second radiation line.

7. The microstrip composite antenna according to claim 1, wherein the first radiation line is located in a first layer below the middle section the second pin is soldered to the PCB through a second pad located in the first layer, the first end located on one side of the second support section is connected to the signal input and/or output point located on the other side of the second support section through an extension wire, wherein,
a notch is provided at the end of the second support section, and the extension wire passes underneath the notch; or,
the extension wire is connected to the first end bypassing the second pad in the first layer.

8. The microstrip composite antenna according to claim 7, wherein when the extension wire passes underneath the notch, the end of the second support section forms two symmetrical second pins centered on the notch, wherein,
the two symmetric second pins are both connected to the ground plane of the PCB through at least one capacitor; or,
one of the two symmetric second pins is connected to the ground plane of the PCB through at least one capacitor, and the other second pin is vacant.

9. The microstrip composite antenna according to claim 7, wherein a width of the notch is not less than 1.2 times a width of the extension wire.

10. The microstrip composite antenna according to claim 1, wherein a frequency band of the microstrip composite antenna ranges from 310 to 490 MHz, a length L of the strip radiation antenna ranges from 22 to 50 mm, a height H of the strip radiation antenna ranges from 5 to 10 mm, and a width W of the strip radiation antenna ranges from 3 to 8 mm.

11. The microstrip composite antenna according to claim 1, wherein a resonant frequency of the microstrip composite antenna is within a frequency band from 431 to 437 MHz, and dimensions of the strip radiation antenna are: length L=26 mm, height H=7 mm, and width W=6 mm.

12. The microstrip composite antenna according to claim 1, wherein a thickness of the strip radiation antenna ranges from 0.2 to 1.0 mm.

13. The microstrip composite antenna according to claim 1, wherein a length of the first radiation line is not less than half of a length of the middle section.

14. The microstrip composite antenna according to claim 1, wherein,
a ratio of a width of the second radiation line to a width of the strip radiation antenna ranges from 0.8 to 1.2.

15. The microstrip composite antenna according to claim 1, wherein,
a long side of an orthogonal projection of the strip radiation antenna on the PCB is parallel to at least one edge of the ground plane, and a distance between the long side and the edge is not less than 6 mm.

16. The microstrip composite antenna according to claim 1, wherein a dielectric constant of a substrate of the PCB is not more than 5.5.

17. The microstrip composite antenna according to claim 1, wherein,
the strip radiation antenna is formed by at least one of:
stamping a strip-shaped metal sheet to obtain the middle section, the first support section, and the second support section; or
bending the strip-shaped metal sheet to obtain the middle section, the first support section, and the second support section.

18. The microstrip composite antenna according to claim 1, wherein a signal processing module is integrated on the PCB, and the signal processing module is connected to the signal input/output point, and the signal processing module is configured to perform at least one of:
demodulating the keying modulation signal received by the microstrip composite antenna; or,
transmitting the modulated keying modulation signal to surrounding space by the microstrip composite antenna.

19. An integrated circuit board, wherein the integrated circuit board comprises a controller, a signal processer, an interface and the microstrip composite antenna according to claim 1, wherein,
the first end of the microstrip radiation line in the microstrip composite antenna is connected to the signal processer, and the signal processer is configured to perform at least one of: demodulating keying modulation signal received through the microstrip composite antenna, or transmitting the modulated keying modulation signal to surrounding space through the microstrip composite antenna.

20. A vehicle, wherein the vehicle is equipped with the microstrip composite antenna according to claim 1.
